(19) United States
(12) Patent Application Publication
(10) Pub. No.: US 2026/0188308 A1
(43) Pub. Date: Jul. 2, 2026

(54) BIAS DETECTION AND MITIGATION WITH QUADRATIC ALGORITHM SELECTION

(71) Applicant: International Business Machines Corporation, Armonk, NY (US)

(72) Inventors: Aaron Keith Baughman, Cary, NC (US); Shikhar Kwatra, San Jose, CA (US); Gandhi Sivakumar, Mountain View, CA (US); Naeem Altaf, Round Rock, TX (US); Rizwan Dudekula, Bengaluru (IN); Wesley McMillan Devine, Clemson, SC (US)

(21) Appl. No.: 19/007,878

(22) Filed: Jan. 2, 2025

(51) Int. Cl. G10L 15/06; G10L 15/183; G10L 25/51

(52) U.S. Cl. CPC G10L 15/063; G10L 15/183; G10L 25/51

(57) ABSTRACT

One or more systems, devices, computer program products and/or computer-implemented methods of use provided herein relate to bias detection and mitigation with quadratic algorithm selection. For example, a system can comprise a memory that can store computer executable components and a processor that can execute the computer executable components stored in the memory. The computer executable components can comprise an identification component that identifies one or more entities in one or more utterances. The computer executable components can further comprise a simulation component that generates simulated utterances based on the one or more entities. The computer executable components can further comprise a model component that executes the simulated utterances on nodes of a natural language processing model to identify bias. The computer executable components can further comprise a selection component that mitigates the bias by selecting one or more debiasing methods using quadratic algorithm selection.

### BACKGROUND

The subject disclosure relates to natural language processing and, more specifically, to bias detection and mitigation with quadratic algorithm selection.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that facilitate bias detection and mitigation with quadratic algorithm selection are discussed.

According to an embodiment, a system is provided. The system can comprise a memory that can store computer executable components. The system can further comprise a processor that can execute the computer executable components stored in the memory, where the computer executable components can comprise an identification component that identifies one or more entities in one or more utterances. The computer executable components can further comprise a simulation component that generates simulated utterances based on the one or more entities. The computer executable components can further comprise a model component that executes the simulated utterances on nodes of a natural language processing model to identify bias. The computer executable components can further comprise a selection component that mitigates the bias by selecting one or more debiasing methods using quadratic algorithm selection.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate bias detection and mitigation with quadratic algorithm selection in accordance with one or more embodiments described herein.

FIG. 2 illustrates another block diagram of an example, non-limiting system that can facilitate bias detection and mitigation with quadratic algorithm selection in accordance with one or more embodiments described herein.

FIG. 3 illustrates a diagram of an example, non-limiting system architecture that can facilitate bias detection and mitigation with quadratic algorithm selection in accordance with one or more embodiments described herein.

FIG. 4 illustrates an example, non-limiting block diagram showing identification of entities from an utterance in accordance with one or more embodiments described herein.

FIG. 5 illustrates an example, non-limiting block diagram showing identification of matching equivalents for an entity in accordance with one or more embodiments described herein.

FIG. 6 illustrates an example, non-limiting block diagram showing generation of stub sentences in accordance with one or more embodiments described herein.

FIG. 7 illustrates an example, non-limiting block diagram showing generation of responses from stub sentences in accordance with one or more embodiments described herein.

FIG. 8 illustrates a diagram of an example, non-limiting graphical user interface of a bias dashboard in accordance with one or more embodiments described herein.

FIG. 9 illustrates a diagram of an example, non-limiting bias mitigation algorithm in accordance with one or more embodiments described herein.

FIG. 10 illustrates an example, non-limiting block diagram that can facilitate bias mitigation in accordance with one or more embodiments described herein.

FIG. 11 illustrates an example, non-limiting block diagram that can facilitate measurement of a liveness metric in accordance with one or more embodiments described herein.

FIG. 12 illustrates a flow diagram of an example, non-limiting method that can facilitate bias detection and mitigation with quadratic algorithm selection in accordance with one or more embodiments described herein.

FIG. 13 illustrates a flow diagram of an example, non-limiting method that can facilitate bias detection and mitigation with quadratic algorithm selection in accordance with one or more embodiments described herein.

FIG. 14 illustrates a flow diagram of an example, non-limiting method that can facilitate bias detection and mitigation with quadratic algorithm selection in accordance with one or more embodiments described herein.

FIG. 15 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Artificial intelligence (AI) has become integral to applications across various sectors, from customer service and technical support to complex decision-making systems. At the core of many AI systems is natural language processing (NLP), which enables machines to interpret and respond to human language. Many NLP-based systems are designed with workflows where individual nodes recognize specific intents based on user input, producing relevant responses. Intent is the underlying purpose or goal of a user's input in an NLP system, representing what the user wants to achieve (e.g., asking for information, making a request). The responses generated are often adjusted with rules that consider various factors, such as specific entities or context within the input. An entity is a specific element or keyword in the user's input that provides additional context for intent detection (e.g., “restaurant” or “appointment” in a query about scheduling a reservation).

However, one key challenge in NLP for AI applications is addressing bias. Bias is a tendency in a model or dataset that leads to unfair or skewed outcomes. In NLP, this often means the model favors certain words, expressions, or sentence structures based on its training data, which can lead to inaccurate or unequal results across different user inputs. In particular, biases arising from “bag of words” (BoW) techniques that, while boosting confidence in intent recognition, can result in skewed interpretations favoring particular sentence structures or expressions. BoW is a text representation method in NLP where a sentence is broken down into individual words, disregarding grammar or word order, and treating each word as a separate feature for analysis. By disregarding word order and context, BoW fails to capture the relationships between words, which can lead to misinterpretations of intent, especially when the same words have different meanings depending on their arrangement. Additionally, the model may overemphasize frequently occurring words, skewing results toward popular expressions while neglecting less common but valid alternatives. This focus can reinforce existing biases in the training data, resulting in inadequate responses to unconventional language uses. Furthermore, BoW reduces sensitivity to nuances such as sarcasm or idiomatic expressions, ultimately compromising the accuracy of intent detection.

Thus, methods and techniques (or schemes) to identify and mitigate bias in NLP for BoW can be desirable.

Various embodiments of the present disclosure can be implemented to produce a solution to these problems. Embodiments described herein include systems, computer-implemented methods, and computer program products that can identify BoW biases and mitigate the biases identified. The methods and techniques described herein to mitigate the biases can select, using quadratic algorithm selection, an optimal combination of debiasing methods that minimizes bias and maximizes liveness (e.g., human like language) in responses to utterances received as input. As a result, this can improve the effectiveness and reliability of NLP models such as virtual assistants.

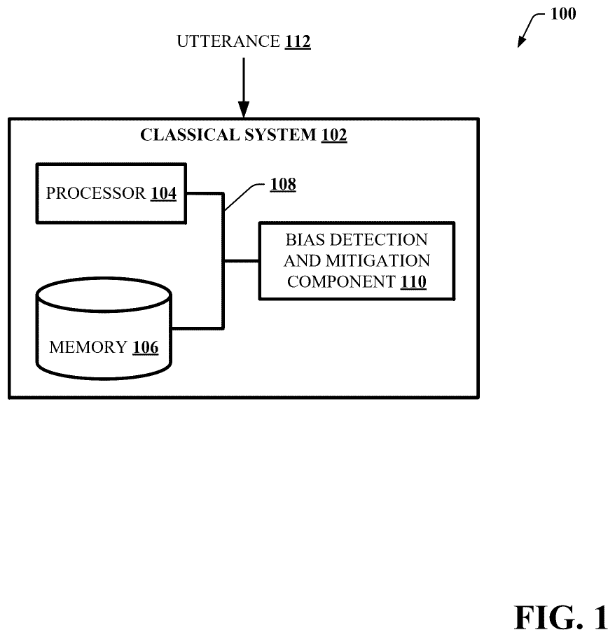

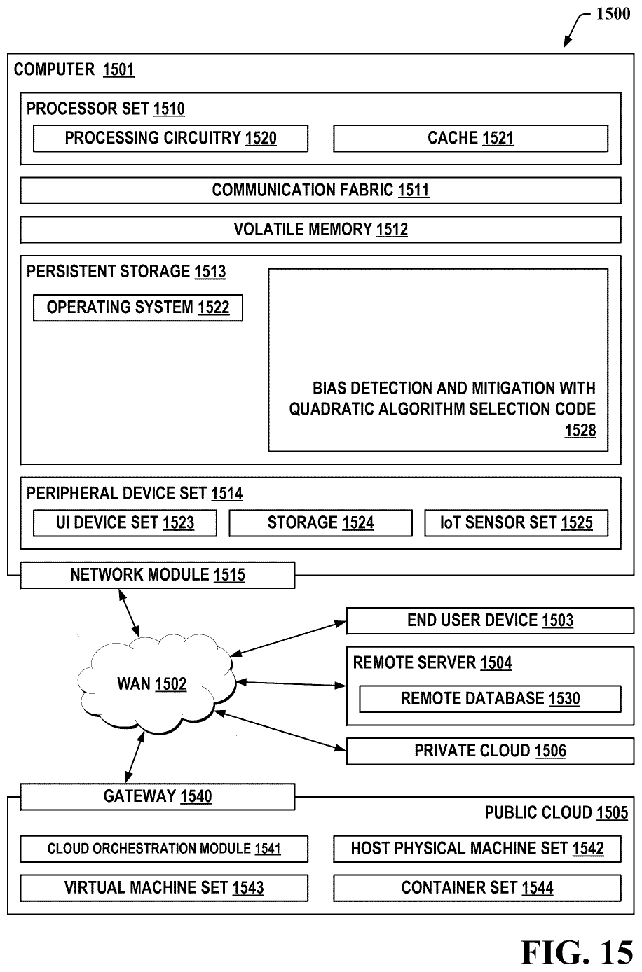

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1500 illustrated at FIG. 15. For example, non-limiting system 100 can be associated with, such as accessible via, a computing environment 1500 described below with reference to FIG. 15, such that aspects of processing can be distributed between non-limiting system 100 and the computing environment 1500. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can facilitate bias detection and mitigation with quadratic algorithm selection in accordance with one or more embodiments described herein.

Non-limiting system 100 and/or the components of non-limiting system 100 can be employed to use hardware and/or software to solve problems that are highly technical in nature (e.g., related to natural language processing, virtual assistants, bias mitigation, etc.), that are not abstract and that cannot be performed as a set of mental acts by a human. Further, some of the processes performed may be performed by specialized computers for carrying out defined tasks related to bias detection and mitigation with quadratic algorithm selection. Non-limiting system 100 and/or components of non-limiting system 100 can be employed to solve new problems that arise through advancements in technologies mentioned above, computer architecture, and/or the like. Non-limiting system 100 can provide technical improvements to natural language processing by identifying and mitigating biases while maintaining liveness in natural language processing responses, etc.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., bias detection and mitigation component 110, identification component 202, simulation component 204, model component 206, selection component 208 and/or display component 210) to perform one or more actions. In one or more embodiments, memory 106 can store computer-executable components (e.g., bias detection and mitigation component 110, identification component 202, simulation component 204, model component 206, selection component 208, and/or display component 210).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

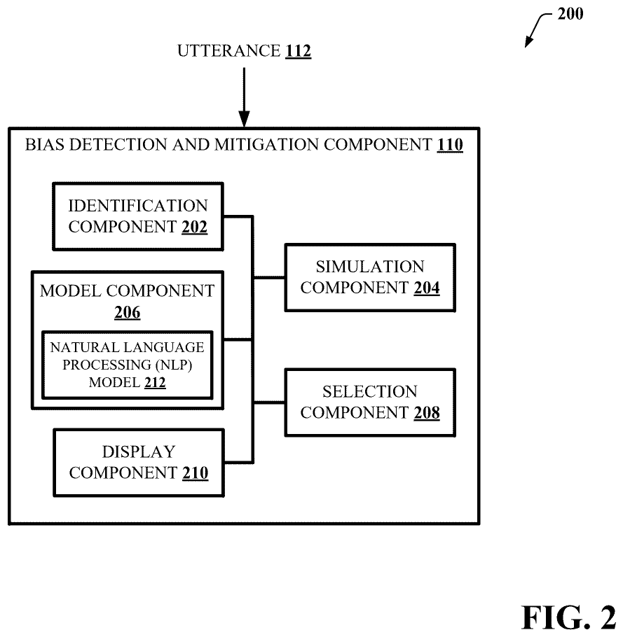

In various embodiments, bias detection and mitigation component 110 can comprise identification component 202, simulation component 204, model component 206, selection component 208, and/or display component 210, as illustrated in FIG. 2.

In various embodiments, identification component 202 can receive an utterance 112 (e.g., a query, a prompt, an input). In various instances, identification component 202 can receive more than one of utterance 112. In natural language processing (NLP), an utterance refers to a single unit of language input (e.g., input from an end user). For example, utterance 112 can be a phrase, sentence, or set of words provided by the user. In various cases, utterance 112 can be a question, command, or statement. As a non-limiting example, utterance 112 can be the command “Set a timer for 10 minutes”. As another non-limiting example, utterance 112 can be the question “What is the weather like today”. As yet another non-limiting example, utterance 112 can be the request “What are my account balance and recent transactions?”. As still another non-limiting example, utterance 112 can be the statement “I need help resetting my password”. As even another non-limiting example, utterance 112 can be the clarification “Show me flights from New York to Los Angeles”.

In various embodiments, identification component 202 can receive utterance 112 from a training dataset. In various aspects, the training dataset can comprise any suitable number of utterances that can be collected from various sources (e.g., real user interactions, simulated conversations, knowledge base articles, third-party datasets, curated examples). As a non-limiting example, the training dataset can collect the utterances from chat logs or conversations from interacting users with a virtual assistant in various contexts (e.g., customer support, helpdesk queries). As another non-limiting example, the training dataset can collect the utterances from constructed dialogues that reflect expected user interactions. As yet another non-limiting example, the training dataset can collect the utterances from queries that users input into search engines that can provide insight into what information they are seeking. As still another non-limiting example, the training dataset can collect the utterances from content from FAQs or help documentation that can be rephrased into user queries.

In various embodiments, utterance 112 can comprise any suitable format. For example, utterance 112 can be in an audio format or a text format. Utterances in an audio format can be spoken language input that is recorded (e.g., from voice commands, customer service calls, voice feedback). Utterances in a text format can be written natural language input that is received (e.g., from chat logs, search queries, knowledge base articles).

In various embodiments, identification component 202 can identify one or more entities in utterance 112. In various cases, identification component 202 can utilize any suitable method to identify the one or more entities, such as Named Entity Recognition. For example, identification component 202 can employ rule-based methods, statistical methods, machine learning methods, or deep learning methods to identify the one or more entities. In any case, identification component 202 can identify one or more entities in utterance 112. As a non-limiting example, identification component 202 can extract the entities “meeting” and “Tuesday” from the utterance “The meeting is scheduled for Tuesday.”

In various embodiments, simulation component 204 can generate simulated utterances from utterance 112. Specifically, simulation component 204 can generate the simulated utterances based on the one or more entities identified in utterance 112. In various embodiments, simulation component 204 can generate the simulated utterances by replacing the one or more entities in utterance 112 with equivalent matches to form stub sentences. In various aspects, simulation component 204 can form the stub sentences in parts and in entirety. That is, simulation component 204 can create variations of utterance 112 in part by replacing only one entity with different equivalent matches to form stub sentences. As a non-limiting example, simulation component 204 can create the following stub sentences in part from the utterance “The toddler was riding a bike down the street.”:

“The kid was riding a bike down the street.”

“The toddler was riding a bike down the street.”

“The toddler was riding a bike down the road.”

“The toddler was riding a bicycle down the street.”:

To create variations of utterance 112 in entirety, simulation component 204 can replace all entities with equivalent matches. As a non-limiting example, simulation component 204 can create the following stub sentences in entirety from the utterance “The toddler was riding a bike down the street.”:

“The kid was riding a bicycle down the road.”

“The toddler was riding a bicycle down the road.”

In some instances, simulation component 204 can also create stub sentences by replacing a subset of the entities in utterance 112 with equivalent matches (e.g., “The kid was riding a bike down the road”, “The toddler was riding a bicycle down the road.”).

In various embodiments, model component 206 can electronically store, electronically maintain, electronically control, or otherwise electronically access the NLP model 212. In various aspects, the NLP model 212 can have or otherwise exhibit any suitable internal architecture. For instance, the NLP model 212 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

In various embodiments, the selection component 208 can electronically store, maintain, control, or otherwise access the natural language processing (NLP) model 212. In various aspects, the NLP model 212 can exhibit any suitable internal architecture. For instance, the NLP model 212 can include an input layer, one or more hidden layers, and an output layer. Each layer consists of multiple nodes (or neurons) that perform computations. In various instances, these nodes can be connected by suitable connections, such as feedforward connections, skip connections, or recurrent connections. Furthermore, in various cases, any of these nodes can utilize learnable or trainable internal parameters. For example, the nodes in the input layer, hidden layers, or output layer can be transformer nodes, whose learnable parameters may include attention weights. As another example, the nodes can be part of dense layers, whose learnable parameters can include weight matrices or bias values. Additionally, nodes in normalization layers can have learnable parameters such as scale factors or shift factors. Further, in various cases, any of these nodes can represent suitable types with fixed or non-trainable internal parameters, such as non-linearity nodes, padding nodes, pooling nodes, or concatenation nodes.

In various aspects, each node within NLP model 212 can be assigned a specific intent. In various embodiments, model component 206 can train each node on a set of user inputs, where each node is expected to respond with its assigned intent. In some cases, the NLP model 212 can be a virtual assistant (e.g., for assisting end users in installation or trouble shooting). In such cases, each node of the NLP model 212 can be trained on a variation of utterances and assigned to a particular intent. Additionally, rules can be optionally applied (e.g., based on user preferences) depending upon various criteria on entities for responding back to the user.

Regardless of the internal architecture of NLP model 212, NLP model 212 can be configured to perform tasks such as responding to user inquiries, providing information, or providing responses based on input utterances. Accordingly, model component 206 can electronically execute NLP model 212 on the simulated utterances (e.g., the stub sentences), thereby yielding corresponding responses to the simulated utterances.

In various embodiments, model component 206 can compare the corresponding responses to determine a bias towards the one or more entities. More specifically, model component 206 can compare the response resulting from execution on utterance 112 against the response resulting from execution on a stub sentence using a matching equivalent to identify the bias towards the matching equivalent. In various aspects, model component 206 can further identify the bias towards different matching equivalents of the entity by comparing the responses resulting from execution of stub sentences with different matching equivalents.

Furthermore, in various embodiments, identification component 202 can process utterance 112 (one or more utterances) using a BoW model. The BoW model can involve tokenizing utterance 112 into words and creating a BoW vector that counts occurrences of each word in utterance 112.

FIG. 2 illustrates a block diagram of an example, non-limiting system 200 that can facilitate bias detection and mitigation with quadratic algorithm selection in accordance with one or more embodiments described herein. Repetitive description of like elements and/or processes employed in respective embodiments is omitted for sake of brevity.

As described with reference to FIG. 1, bias detection and mitigation component 110 can comprise identification component 202, simulation component 204, model component 206, selection component 208 and/or display component 210. In this regard, non-limiting system 200 describes the system of bias detection and mitigation component 110 that can facilitate bias detection and mitigation with quadratic algorithm selection.

In various aspects, bias detection and mitigation component 110 can receive utterance 112, where it can be desirable to identify and mitigate bias across entities. Embodiments described herein provide a method to identify and mitigate biases for bag of words across intents. In various embodiments, bias detection and mitigation component 110 can identify matching equivalents of entities identified in utterance 112, and simulate utterances (e.g., stub sentences) by replacing the entities in utterance 112 with the matching equivalents. Thereafter, bias detection and mitigation component 110 can execute NLP model 212 on the simulated utterances to generate responses. As a result, bias detection and mitigation component 110 can identify the biases across entities based on the generated responses. Accordingly, in various embodiments, bias detection and mitigation component 110 can mitigate the identified biases using quadratic algorithm selection. Particularly, bias detection and mitigation component 110 can use quadratic algorithm selection to determine an optimal combination of debiasing methods (e.g., fair processing phases) to apply to minimize bias. In various embodiments, to maintain liveness in the responses generated by NLP model 212, such as for applications in virtual assistants, bias detection and mitigation component 110 can employ a liveness metric in quadratic algorithm selection to enable obtaining of a combination of debiasing methods that will maximize liveness and minimize bias.

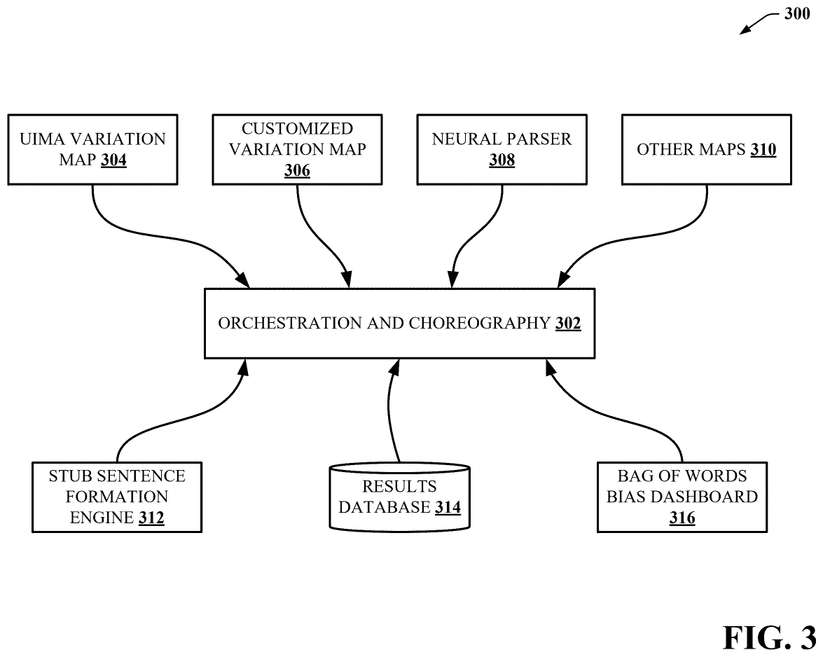

FIG. 3 illustrates a diagram of an example, non-limiting system architecture 300 that can facilitate bias detection and mitigation with quadratic algorithm selection in accordance with one or more embodiments described herein. Repetitive description of like elements and/or processes employed in respective embodiments is omitted for sake of brevity.

In various embodiments, bias detection and mitigation component 110 can perform orchestration and choreography 302. The bias detection and mitigation component 110 can electronically store, electronically maintain, electronically control, or otherwise electronically access Unstructured Information Management Architecture (UIMA) variation map 304, customized variation map 306, neural parser 308, other maps 310, stub sentence formation engine 312, results database 314, and bag of words bias dashboard 316.

In various aspects, the UIMA variation map 304 can store entities and variations of the entities in a structured data format. For example, the UIMA variation map 304 can store details of each entity and its corresponding variation across different conditions, configurations, or scenarios.

In various embodiments, the customized variation map 306 can comprise non-generic entities (e.g., entities that are not universally known, entities that are specific or customized to a particular organization). For example, “street” and “road” is a universally known entity variation, and thus can be comprised in UIMA variation map 304. Conversely, “Business Contact Guidelines” and “BCG” can be an entity variation that is specific to a particular organization (e.g., “BCG” is not a universally known acronym for “Business Contact Guidelines”). Therefore, “Business Contact Guidelines” and “BCG” can be an entity variation that is stored in the customized variation map 306.

In various aspects, the other maps 310 can comprise any suitable additional variation maps to UIMA variation map 304 and customized variation map 306. For example, the other maps 310 can be third-party exposed variation maps.

In various instances, identification component 202 can electronically store, electronically maintain, electronically control, or otherwise electronically access neural parser 308. In various aspects, identification component 202 can employ the neural parser 308 to analyze and generate a syntactic or semantic structure (e.g., parse tree or graph) for utterance 112. In various cases, the neural parser 308 can comprise any suitable internal architecture. In any case, the neural parser 308 can fragment the utterance 112 to identify entities. Further, the neural parser 308 can tag the entities. In other words, the neural parser can assign the entities to classes.

In various embodiment, simulation component 204 can electronically store, electronically maintain, electronically control, or otherwise electronically access stub sentence formation engine 312. That is, simulation component 204 can employ the stub sentence formation engine 312 to generate stub sentences using matching equivalents identified from the variation maps.

In various embodiments, the responses generated from executing the NLP model 212 on the stub sentences can be stored in the results database 314 for subsequent use or access to identify bias across entities. Furthermore, after identifying the bias, display component 210 can visually render the biases identified in the bag of words bias dashboard 316.

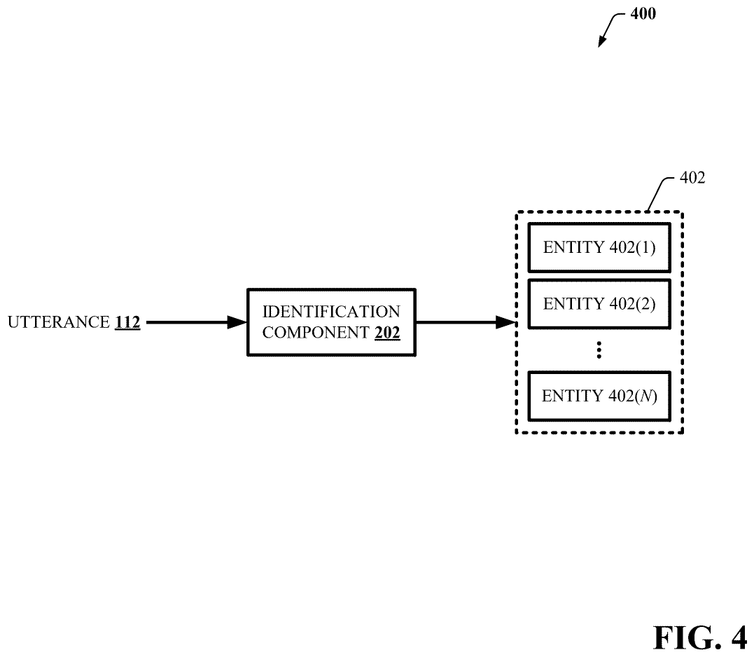

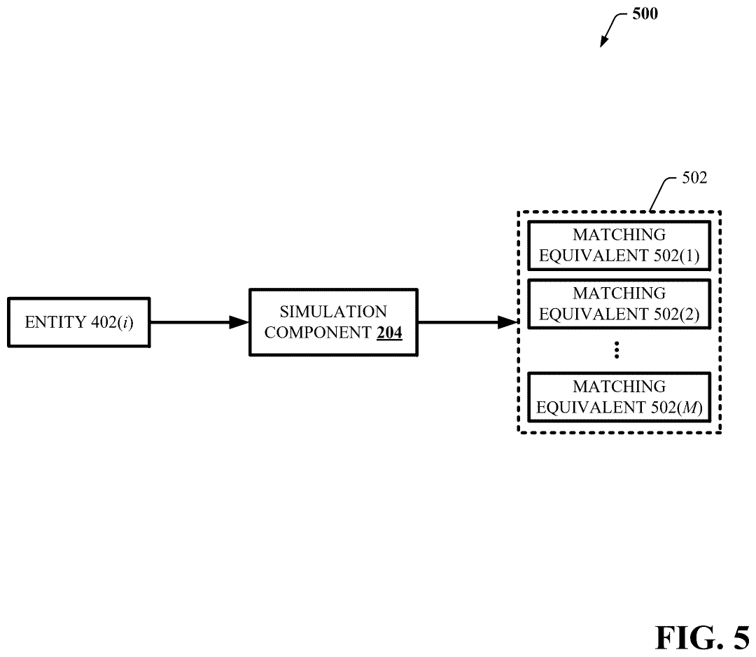

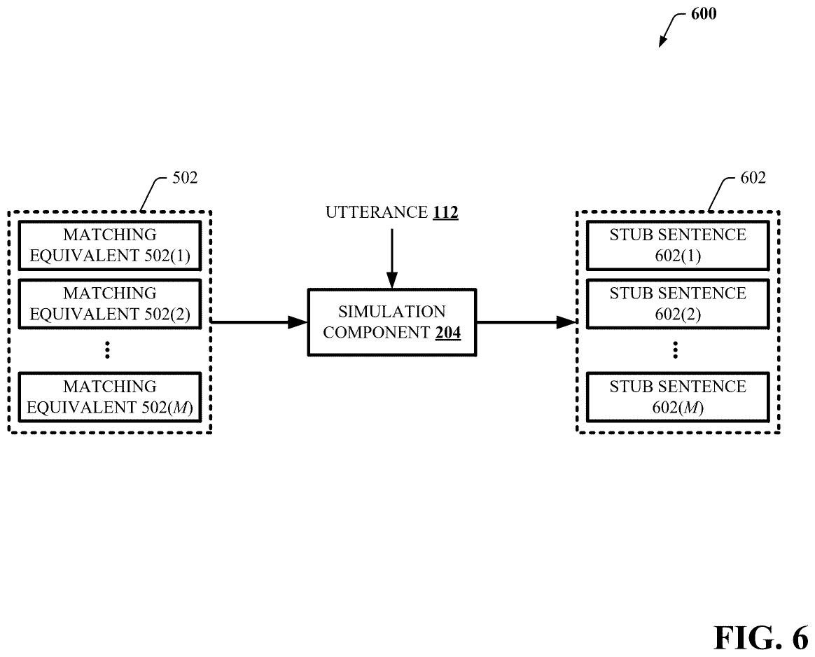

FIGS. 4-6 illustrate example, non-limiting block diagrams 400, 500, and 600 showing simulation of utterances in accordance with one or more embodiments described herein. Repetitive description of like elements and/or processes employed in respective embodiments is omitted for sake of brevity.

In various embodiments, identification component 202 can receive utterance 112 as input. As a result, identification component 202 can identify entities 402 from utterance 112. In various embodiments, identification component 202 can utilize any suitable method to identify the entities 402, such as names entity recognition (NER), rule-based systems, or natural language processing. In any case, identification component 202 can identify any number of entities 402 in utterance 112. That is, entities 402 can comprise any positive integer n of entities 402: an entity 402(1) to an entity 402(n).

In various embodiments, for each entity 402(i) identified in utterance 112, simulation component 204 can identify matching equivalents 502 of entity 402(i). That is, simulation component 204 can identify any positive integer m of matching equivalents 502: a matching equivalent 502(1) to a matching equivalent 502(m).

In various aspects, for each matching equivalent 502(j) to entity 402(i), simulation component 204 can replace the entity 402(i) in utterance 112 with the matching equivalent 502(j). As a result, simulation component 204 can generate stub sentences 602. That is, simulation component 204 can generate a stub sentence 602(1) to a stub sentence 602(m), where stub sentence 602(j) is utterance 112 with entity 402(i) replaced with matching equivalent 502(j).

In various embodiments, simulation component 204 can generate the stub sentences 602 for each variation in part or in entirety, as described with respect to FIG. 1. In such cases, simulation component 204 can generate additional stub sentences that account for each variation in part or for each variation in entirety.

Furthermore, in various aspects, simulation component 204 can generate stub sentences 602 for different sentence types. For instance, if utterance 112 can be expressed as a command or as a question, simulation component 204 can generate a stub sentence of utterance 112 as a command and another stub sentence of utterance 112 as a request. In various cases, the entities 402 in utterance 112 can remain unchanged (e.g., not replaced by matching equivalents 502) for creating stub sentences for different sentence types.

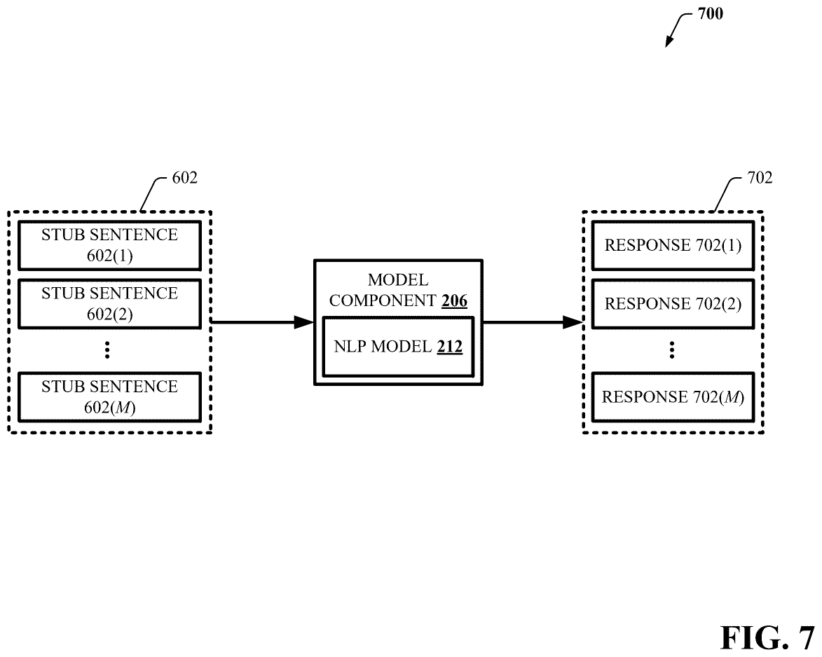

FIG. 7 illustrates an example, non-limiting block diagram 700 showing generation of responses from stub sentences in accordance with one or more embodiments described herein. Repetitive description of like elements and/or processes employed in respective embodiments is omitted for sake of brevity.

In various embodiments, model component 206 can execute the NLP model 212 on the stub sentences 602 to generate responses 702: a response 702(1) to a response 702(m). That is, model component 206 can execute the NLP model 212 on any stub sentence 602(j) to generate a response 702(j). In various aspects, model component 206 can execute the stub sentences 602 on each node in the NLP model 212. Thus, based on the responses 702 generated from such execution, model component 206 can identify the bias across entities (or sentence types).

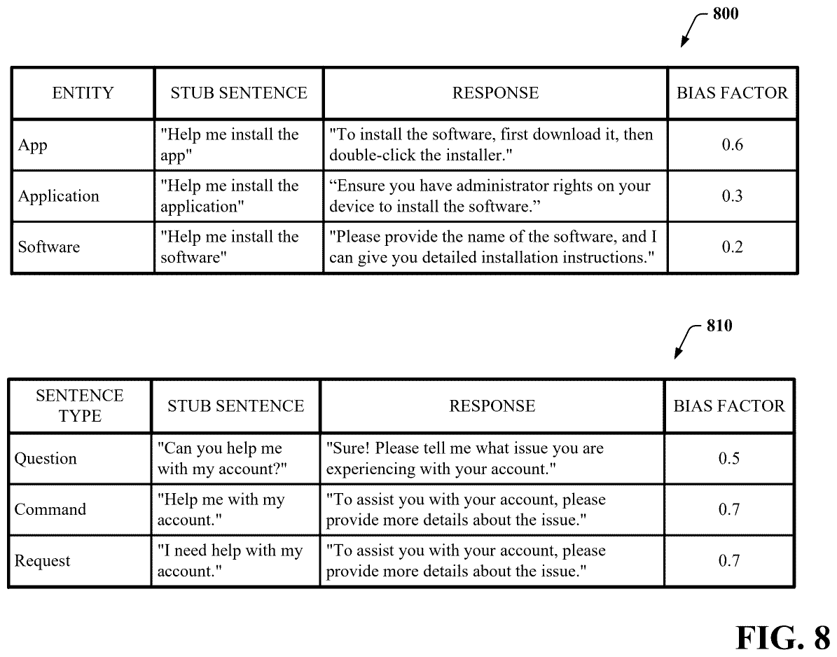

FIG. 8 illustrates a diagram of an example, non-limiting bag of words bias dashboard 800 and 810 in accordance with one or more embodiments described herein. Repetitive description of like elements and/or processes employed in respective embodiments is omitted for sake of brevity.

In various embodiments, the display component 210 can electronically render, on any suitable electronic display of any suitable computing device (e.g., computer screen, computer monitor, graphical user-interface), the non-limiting bag of words bias dashboard 800 and 810. That is, in various instances, the display component 210 can visually render a user interface that can provide a view for each of entities 402 and corresponding bias factors, based on the various inferences produced by the NLP model 212.

More specifically, in various embodiments, the model component 206 can identify, via NLP model 212, biases of entities 402, and the display component 210 can visually render the identified biases in a dashboard on the user interface.

As an example, the non-limiting bag of words bias dashboard 800 and 810 can display corresponding bias factors for each entity and its matching equivalents. As described with respect to FIG. 7, the NLP model 212 can determine the corresponding bias factors based on the response generated from the utterance 112 in comparison to the responses 702 generated from stub sentences 602. Accordingly, display component 210 can display such bias factors on the user interface.

As a non-limiting example, identification component 202 can receive utterance 112 which can state “Help me install the app”. Thereafter, identification component 202 can identify “app” as an entity and identify matching equivalents of the entity (e.g., from UIMA variation map 304, customized variation map 306, or other maps 310). Accordingly, simulation component 204 can generate stub sentences with the matching equivalents. For instance, simulation component 204 can generate the stub sentences “Help me install the application” and “Help me install the software” where “application” and “software” are the matching equivalents. No matter the matching equivalents identified, model component 206 can execute NLP model 212 on the utterance and the stub sentences to generate corresponding responses. As a result, model component 206 can identify a bias factor for each matching equivalent based on the corresponding responses generated. Accordingly, the non-limiting bag of words bias dashboard 800 can display the bias factor for each matching equivalent. For instance, as depicted in FIG. 8, “app” can have a bias factor of 0.6 and “application” can have a bias factor of 0.3.

In various embodiments, the bias dashboards can display the bias factors of different sentence types. For example, in the non-limiting bag of words bias dashboard 810, utterance 112 can be expressed as a command, a question, or a request. Accordingly, display component 210 can display the bias factor for each sentence type of utterance 112. For instance, as shown in FIG. 7, utterance 112 when expressed as a question can have a bias factor of 0.5 whereas utterance 112 when expressed as a command can have a bias factor of 0.7.

In various embodiments, the bias dashboards displayed by display component 210 can utilize any suitable format, structure, or layout to display the bias factors of the entities across intents.

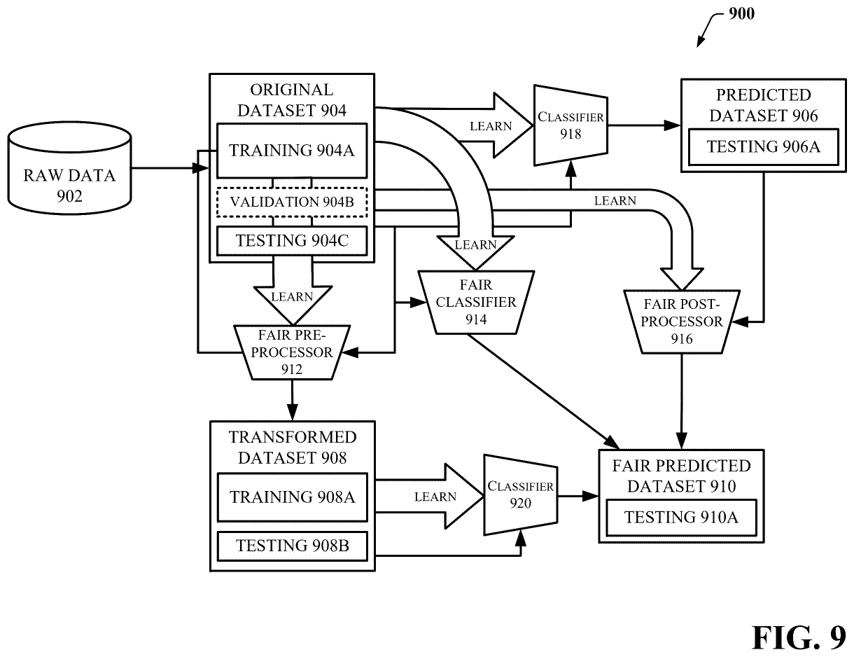

FIG. 9 illustrates a diagram of an example, non-limiting bias mitigation algorithm 900 in accordance with one or more embodiments described herein. Repetitive description of like elements and/or processes employed in respective embodiments is omitted for sake of brevity.

In various instances, the raw data 102 can be any suitable electronic data exhibiting any suitable format, size, or dimensionality. That is, raw data 902 can be one or more scalars, one or more vectors, one or more matrices, one or more tensors, one or more character strings, or any suitable combination thereof. In various embodiments, raw data 902 can comprise any data for training, testing, validating, or inferencing with NLP model 212. For example, raw data 902 can include, for training NLP model 212, labeled or unlabeled datasets.

In various aspects, model component 206 can perform data pre-processing on raw data 902. Thereafter, an original dataset 904 can be obtained from the raw data 902. The original dataset 904 can be split into training set 904A, validation set 904B, and testing set 904C. In various aspects, original dataset 904 can undergo fair pre-processing, fair in-processing, or fair post-processing to generate a fair predicted dataset 910 via NLP model 212. Which of the fair processing phases that the original dataset 904 undergoes can be determined using quadratic algorithm selection.

In various aspects, fair pre-processing can be applied to the original dataset 904 via a fair pre-processor 914 to generate fair predicted dataset 910. In various embodiments, the fair pre-processor 914 can be trained on training set 904A of the original dataset 904. In other words, model component 206 can learn the fair pre-processor 914 from the training set 904A. Thereafter, the fair pre-processor can be applied to the training set 904A and testing set 904C. In various embodiments, applying fair pre-processing to the original dataset 904 via fair pre-processor 914 can result in transformed dataset 908. That is, transformed dataset 908 can comprise fair data, which can be split into a training set 908A and a testing set 908B. Thereafter, classifier 1120 of NLP model 212 can classify the testing set 908B of transformed dataset 908 to generate fair predicted dataset 910. Alternatively, model component 206 can train the classifier 1120 (e.g., learn classifier 920) using training set 908A of transformed dataset 908. Thus, by fair-preprocessing the original dataset 904 to generate the transformed dataset 908, the transformed dataset 908 can consist of fair data, which can then be used to train classifier 920 to be fair. Accordingly, classifier 920 can be applied to generate fair predicted dataset 910.

In various aspects, the fair pre-processor 914 can preprocess original dataset 904 to mitigate bias by applying techniques that adjust the dataset's distribution and representation before it is used for training. For example, if certain classes (e.g., a category or label assigned to data points in a dataset) are overrepresented in the original dataset 904, the fair pre-processor 914 can oversample a minority class (e.g., a dataset that has significantly fewer examples compared to other classes) to balance the original dataset 904. This can involve duplicating examples from the minority class or generating synthetic samples using any suitable method (e.g., Synthetic Minority Over-sampling Technique, Adaptive Synthetic Sampling, random oversampling, random undersampling). Additionally, the fair pre-processor 914 can perform re-weighting, where examples from underrepresented classes are given higher weights during training, or subsampling, where examples from overrepresented classes are selectively removed.

In various instances, fair in-processing can be applied to the original dataset 904 via a fair classifier 918 to generate fair predicted dataset 910. Similarly to fair pre-processor 914, the fair classifier 918 can also be trained on training set 904A of the original dataset 904. In other words, model component 206 can learn the fair classifier 918 from the training set 904A. Thereafter, the fair classifier 918 can be applied to testing set 904C of the original dataset 904. Accordingly, applying fair classifier 918 to the original dataset 904 can result in fair predicted dataset 910.

In various aspects, the fair classifier 918 can mitigate bias by incorporating fairness constraints or objectives directly into the model training process. For example, the fair classifier 918 can introduce fairness-constrained optimization, which adds to the objective function of NLP model 212. As another example, regularization techniques can be applied to introduce terms into the loss function that penalize overrepresented classes. As yet another example, the fair classifier 918 can adjust sample weights during training to emphasize underrepresented classes.

In other instances, fair post-processing can be applied to the original dataset 904 via a fair post-processor 916 to generate fair predicted dataset 910. More specifically, the original dataset 904 can be inputted into NLP model 212 for inferencing to generate predictions. Such predictions can then be altered via post-processing to debias the predictions. To achieve this, model component 206 can train a classifier 912 (e.g., learn classifier 912) using training set 904A of the original dataset 904. Thereafter, the classifier 912 can be applied to testing set 904C of the original dataset 904 to generate a predicted dataset 906. In various aspects, the fair post-processor 916 can be trained on validation set 904B of the original dataset 904. In other words, model component 206 can learn the fair post-processor 916 from the training set 904A. Thereafter, the fair post-processor 916 can be applied to the predicted dataset 906. In various embodiments, the predicted dataset 906 can comprise a testing set 906A on which the fair post-processor is applied. Accordingly, applying fair post-processing via fair post-processor 916 to predicted dataset 906 can result in the fair predicted dataset 910.

In various aspects, the fair post-processor 916 can mitigate bias by adjusting the outputs of the NLP model 212 after training to ensure fairness without altering the original dataset 904 or the NLP model 212 itself. For example, the fair post-processor 916 can reassign predicted labels to satisfy fairness criteria. This can involve techniques like threshold adjustment, where the decision thresholds for different classes are modified to balance error rates. As another example, the fair post-processor 916 can apply output re-weighting, where predictions in the predicted dataset 906 are re-weighted to correct imbalances in outcomes across classes.

In various embodiments, the fair predicted dataset 910 can comprise a testing set 910A for further testing NLP model 212 for bias mitigation after applying fair pre-processing, fair in-processing, or fair post-processing.

In various embodiments, to select which of the fair processing phases (or a combination thereof) are performed to mitigate the bias (e.g., fair pre-processing, fair in-processing, or fair post-processing), selection component 208 can utilize quadratic algorithm selection. Specifically, selection component 208 can use a binary selector to choose a combination of the fair processing phases (e.g., debiasing methods) based on an optimization of a quadratic function. In various aspects, the quadratic function can be defined by the following equation.

$${f}_{Q} ( x ) = {\sum }_{i = 1}^{n} {\sum }_{j = 1}^{i} {q}_{ij} {x}_{i} {x}_{j}$$

In the quadratic function, ƒ_{Q}(x) measures the bias over all classes within x, where x is a binary vector that represents the selection of the debiasing methods, and where Q represents the bias interactions or weights between the elements of the binary vector x.

Furthermore, in qᵢⱼ can represent coefficients that determine the interactions or bias relationships between different debiasing methods or classes. In other words, qᵢⱼ can quantify how much selecting both debiasing methods xᵢ and xⱼ together contributes to or mitigates bias. In various instances, xᵢ and xⱼ can be binary variables (e.g., 0 or 1) that indicate the selection (1) or non-selection (0) of a particular debiasing method.

In various aspects, x can be considered the binary selector. That is, each component of x (each xᵢ) acts as a binary selector for a corresponding debiasing method (e.g., a corresponding fair processing phase), and the entire vector x can collectively determine which subset of the debiasing methods should be used to minimize the bias across classes.

Since ƒ_{Q}(x) represents the bias over all classes, it can be desirable to minimize the bias, ƒ_{Q}(x), for or against the classes with a minimum number of debiasing methods. Such optimization problem (e.g., minimizing of ƒ_{Q}(x)) can be defined by x*=arg min ƒ(x) where x∈ [symbol] . In various aspects, [symbol] can represent the set of binary vectors of length n (indicating the presence or absence of n possible debiasing methods)

The binary selector can choose which subset of the debiasing methods will minimize the quadratic function ƒ_{Q}(x). In various embodiments, a set of debiasing methods can be received as input, where each debiasing methods corresponds to a component xᵢ of the binary vector x. In various instances, the selection of each debiasing method can be governed by the value of xᵢ, where xᵢ=1 means the debiasing method is selected, and xᵢ=0 means the debiasing method is not selected. In any case, the output can be the optimal vector x* that minimizes the bias, or in other words, the minimum number of debiasing methods that result in the lowest bias across classes. Accordingly, in various embodiments, selection component 208 can receive the set of debiasing methods as input and minimize ƒ_{Q}(x) to output the optimal vector x* that minimizes the bias (e.g., the optimal combination of the debiasing methods to minimize bias across classes).

Although the debiasing methods discussed herein include fair pre-processing, fair in-processing, and fair post-processing, any suitable debiasing methods can be utilized or included. That is, the quadratic algorithm selection is not limited to selecting a combination of such fair processing phases, and can be applied to select a combination of any suitable debiasing methods.

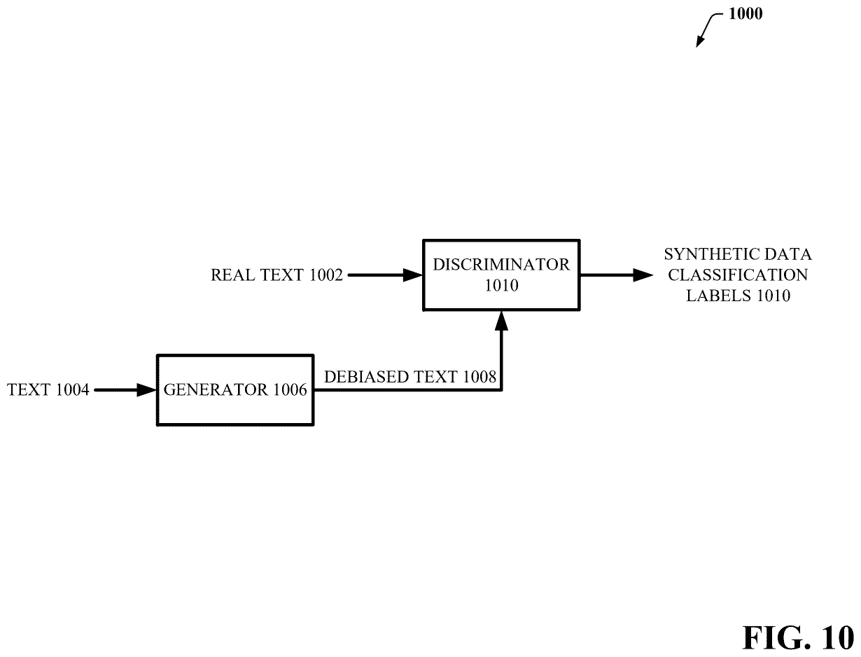

FIG. 10 illustrates a diagram of an example, non-limiting GAN model 1000 that can facilitate bias mitigation in accordance with one or more embodiments described herein. Repetitive description of like elements and/or processes employed in respective embodiments is omitted for sake of brevity.

In various instances, it can be desirable to maintain liveness when performing bias mitigation. Accordingly, selection component 208 can add a liveness metric z(qᵢⱼ) to the quadratic function ƒ_{Q}(x) as described with respect to FIG. 9. Incorporating the liveness metric z(qᵢⱼ) can enhance the quadratic function ƒ_{Q}(x) to account for the need to maintain coherence and flow (e.g., liveness). Thus, selection component 208 can select a combination of debiasing methods that also maximizes liveness. As a non-limiting example, selection component 208 can add the liveness metric z(qᵢⱼ) based on vector distance of entities in sentences generated. For instance, in sequential sentences like “I went to the supermarket,” “I bought a salad in the supermarket,” and “I went to the counter in the supermarket,” the vector distances of entities (e.g., subject/verb/object (SVO)) can be analyzed for overlap. Specifically, if vectors overlap in the SVO components of adjacent sentences, bias mitigation mechanisms ƒ_{Q}(x) can be triggered. Thereafter, selection component 208 can pass the sentences to neural parser 308, which can combine, optimize, and mitigate the bias by selecting an optimal combination of debiasing methods. This can ensure that liveness is maintained while reducing bias across classes.

In various embodiments, selection component 208 can measure the liveness metric via non-limiting GAN model 1000. In various embodiments, selection component 208 can train the non-limiting GAN model 1000 using a training dataset. In various instances, the training dataset can comprise biased text 1002. For example, biased text 1002 can include human-generated text samples (e.g., social media comments, articles, blog posts, and forum discussions). In some cases, biased text 1002 can comprise unbiased or minimally biased human-written text samples into the training dataset. In other instances, biased text 1002 can comprise neutral text samples that exhibit a wide range of human writing without significant bias. Additionally, the training dataset can include annotations identifying specific instances of biased language.

In various embodiments, selection component 208 can electronically store, electronically maintain, electronically control, or otherwise electronically access the non-limiting GAN model 1000. In various aspects, the non-limiting GAN model 1000 can have or otherwise exhibit any suitable internal architecture. For instance, the non-limiting GAN model can consist of a generator 1006 and a discriminator 1008, each having an input layer, one or more hidden layers, and an output layer. In various instances, any of such layers can be coupled together by suitable interneuron connections or interlayer connections, such as forward connections, skip connections, or recurrent connections. Furthermore, in various cases, any of such layers can be of suitable types of neural network layers with learnable or trainable internal parameters. For example, any of the generator's or discriminator's input layer, one or more hidden layers, or output layer can be composed of convolutional layers, whose learnable or trainable parameters include convolutional kernels. As another example, these layers can also be dense layers, with learnable or trainable parameters represented by weight matrices or bias values. As still another example, any of these layers can be batch normalization layers, whose learnable or trainable parameters can consist of shift factors or scale factors. Further still, in various cases, any of such layers can be of suitable types of neural network layers having fixed or non-trainable internal parameters, such as non-linearity layers, padding layers, pooling layers, or concatenation layers.

No matter the internal architecture of the non-limiting GAN model 1000, the non-limiting GAN model 1000 can be configured to generate debiased text outputs based on inputted biased text 1002. Accordingly, selection component 208 can electronically execute the non-limiting GAN model 1000 (e.g., generator 1006) on the input biased text 1002, thereby yielding debiased text 1004.

As shown, the selection component 208 can, in various aspects, execute the generator 1006 on the biased text 1002 and such execution can cause the generator 1006 to produce debiased text 1004. More specifically, the selection component 208 can feed the biased text 1002 to an input layer of generator 1006. In various instances, the biased text 1002 can complete a forward pass through one or more hidden layers of generator 1006. In various cases, an output layer of generator 1006 can compute the debiased text 1004 based on activation maps or intermediate features produced by the one or more hidden layers.

In various embodiments, selection component 208 can execute the discriminator 1008 on the biased text 1002 and the debiased text 1004. Such execution can cause the discriminator 1008 to produce synthetic data classification labels 1010 that can indicate, specify, convey, or otherwise represent whether the input text (e.g., biased text 1002 or debiased text 1004) is human-generated or synthetic data. That is, discriminator 1008 can determine which of biased text 1002 or debiased text 1004 is synthetic data (or which is human-generated). For example, discriminator 1008 can output two synthetic data classification labels 1010, wherein one classification label that indicates the text is not synthetic (e.g., is human-generated) can be assigned to biased text 1002 and one classification label that indicates the text is synthetic (e.g., is not human-generated) can be assigned to debiased text 1004. In other cases, one classification label that indicates the text is synthetic (e.g., is not human-generated) can be assigned to biased text 1002 and one classification label that indicates the text is not synthetic (e.g., is human-generated) can be assigned to debiased text 1004.

In various aspects, the synthetic data classification labels 1010 can be any suitable electronic data exhibiting any suitable format, size, or dimensionality. That is, the synthetic data classification labels 1010 can be one or more scalars, one or more vectors, one or more matrices, one or more tensors, one or more character strings, or any suitable combination thereof.

In various embodiments, training of the non-limiting GAN model 1000 can involve iteratively updating generator 1006 and discriminator 1008. More specifically, based on the synthetic data classification labels 1010, selection component 208 can evaluate the correctness or accuracy of the synthetic data classification labels 1010 to adjust parameters of generator 1006 or discriminator 1008. For example, selection component 208 can compute a discriminator loss based on the accuracy of the synthetic data classification labels 1010 and update the parameters via backpropagation to minimize the discriminator loss. Similarly, for example, selection component 208 can compute a generator loss based on the accuracy of the synthetic data classification labels 1010 and update the parameters via backpropagation to minimize the generator loss. This process can be iteratively performed using the training dataset to train the non-limiting GAN model 1000 to produce debiased text of an input text.

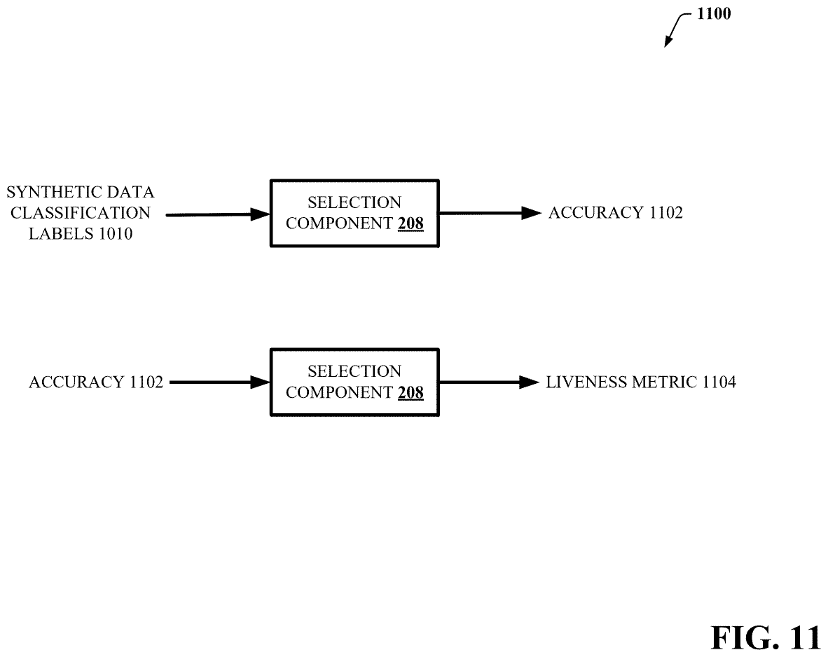

FIG. 11 illustrates an example, non-limiting block diagram 1100 that can facilitate measurement of a liveness metric in accordance with one or more embodiments described herein. Repetitive description of like elements and/or processes employed in respective embodiments is omitted for sake of brevity.

In various embodiments, selection component 208 can determine an accuracy of the synthetic data classification labels 1010 generated by discriminator 1008. For example, the training dataset can comprise a set of ground-truth annotations that comprise correct classification labels of the biased text 1002 and debiased text 1004. Thus, selection component 208 can determine the accuracy over the training dataset by comparing the synthetic data classification labels 1010 to the set of ground-truth annotations for each text sample of the biased text 1002 that selection component 208 executes the non-limiting GAN model 1000 on.

As a non-limiting example, accuracy 1102 can be a binary or binomial variable that can take on one of two possible discrete states. In such case, one of the two possible discrete states can represent a “correct” state, whereas the other of the two possible discrete values can represent an “incorrect” state. That is, accuracy 1102 can take on the “correct” state when the discriminator 1008 infers that the biased text 1002 is not synthetic data (or infers that the debiased text 1004 is synthetic data) and accuracy 1102 can take on the “incorrect” state when the discriminator 1008 instead infers that the biased text 1002 is synthetic data (or infers that the debiased text 1004 is not synthetic data).

In various embodiments, selection component 208 can determine an accuracy over the entire training dataset based on the accuracy 1102 generated for each text sample. Thus, selection component 208 can compute the accuracy of the non-limiting GAN model 1000 over the training dataset. Thereafter, selection component 208 can determine liveness metric 1104 based on the accuracy. That is, selection component 208 can determine liveness metric 1104 based the accuracy 1102 generated for each text sample. As a non-limiting example, the accuracy can be a percentage or fraction that indicates the number of times that the synthetic data classification labels 1010 were correct (e.g., the number of times that accuracy 1102 was in the “correct” state).

In various embodiments, selection component 208 can determine the liveness metric 1104 based on the accuracy 1102 of the non-limiting GAN model 1000. More specifically, the liveness metric can equal an inverse of the accuracy 1102. Therefore, the liveness metric 1104 increases as liveness decreases, and the liveness metric 1104 decreases as liveness increases. This can enable the selection component 208 to select, via the binary selector, a combination of debiasing methods that maximizes liveness.

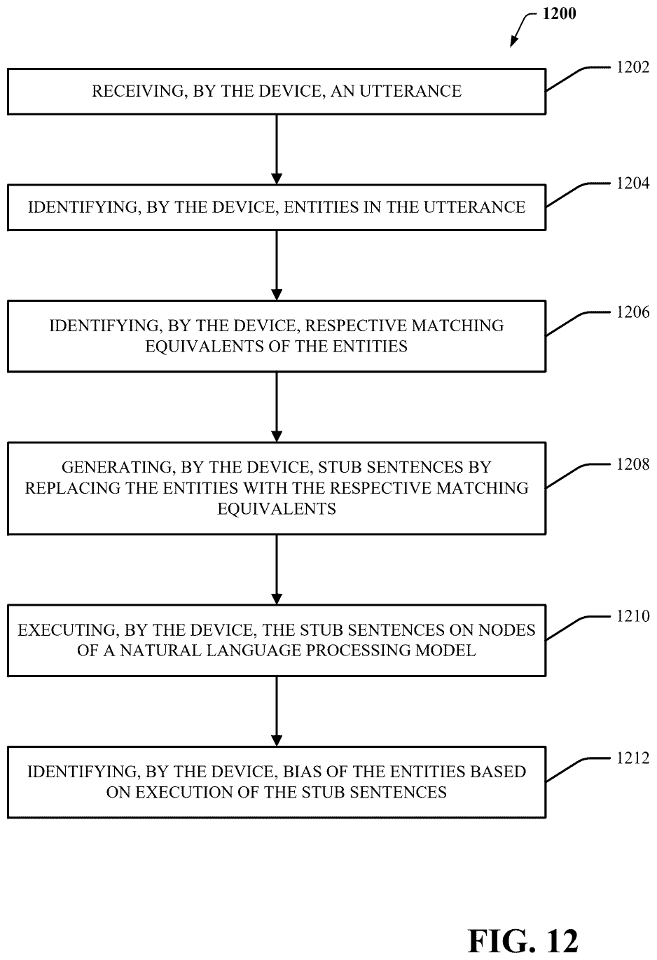

FIG. 12 illustrates a flow diagram of an example, non-limiting method 1200 that can facilitate bias detection and mitigation with quadratic algorithm selection in accordance with one or more embodiments described herein. Repetitive description of like elements and/or processes employed in respective embodiments is omitted for sake of brevity.

At 1202, non-limiting method 1200 can comprise receiving (e.g., by identification component 202), by the system, an utterance.

At 1204, non-limiting method 1200 can comprise identifying (e.g., by identification component 202), by the system, entities in the utterance.

At 1206, non-limiting method 1200 can comprise identifying (e.g., by simulation component 204), by the system, respective matching equivalents of the entities.

At 1208, non-limiting method 1200 can comprise generating (e.g., by simulation component 204), by the system, stub sentences by replacing the entities with the respective matching equivalents.

At 1210, non-limiting method 1200 can comprise executing (e.g., by model component 206), by the system, the stub sentences on nodes of a natural language processing model.

At 1212, non-limiting method 1200 can comprise identifying (e.g., by model component 206), by the system, bias of the entities based on execution of the stub sentences. More specifically, execution of the stub sentences can result in respective responses from the NLP model. Accordingly, non-limiting method 1200 can comprise identifying the bias of each of the equivalent matches in comparison to the entity based on the respective responses.

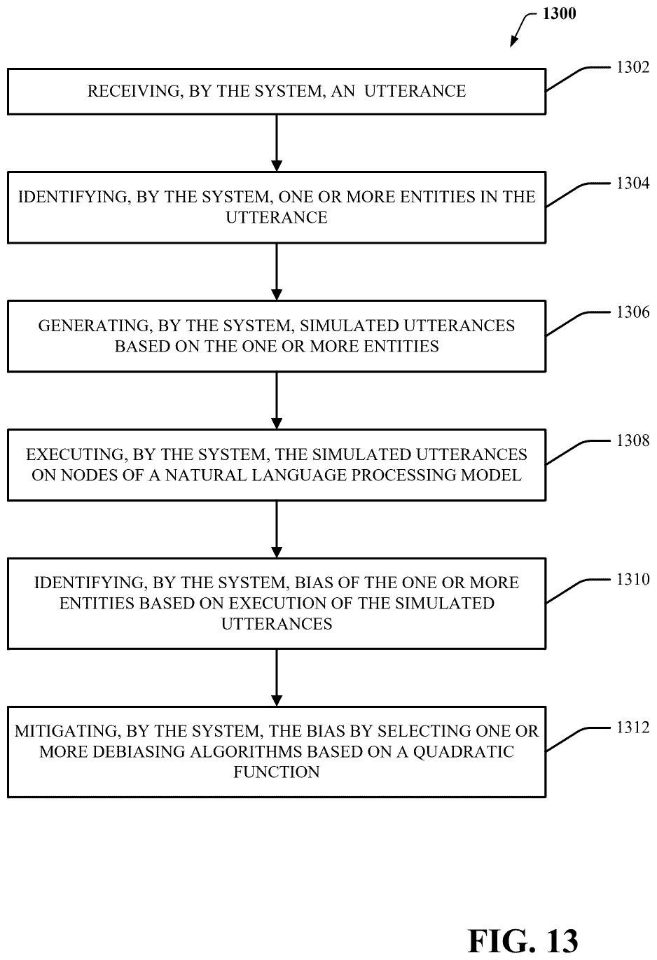

FIG. 13 illustrates a flow diagram of an example, non-limiting method 1300 that can facilitate bias detection and mitigation with quadratic algorithm selection in accordance with one or more embodiments described herein. Repetitive description of like elements and/or processes employed in respective embodiments is omitted for sake of brevity.

At 1302, non-limiting method 1300 can comprise receiving (e.g., by identification component 202), by the system, an utterance.

At 1304, non-limiting method 1300 can comprise identifying (e.g., by identification component 202), by the system, one or more entities in the utterance.

At 1306, non-limiting method 1300 can comprise generating (e.g., by simulation component 204), by the system, simulated utterances based on the one or more entities. In various cases, the simulated utterances can be stub sentences that are created by replacing the one or more entities with respective equivalent matches in the utterance.

At 1308, non-limiting method 1300 can comprise executing (e.g., by model component 206), by the system, the simulated utterances on nodes of a natural language processing model.

At 1310, non-limiting method 1300 can comprise identifying (e.g., by model component 206), by the system, bias of the one or more entities based on execution of these simulated utterances.

At 1312, non-limiting method 1300 can comprise mitigating (e.g., by selection component 208), by the system, the bias by selecting one or more debiasing methods based on a quadratic function.

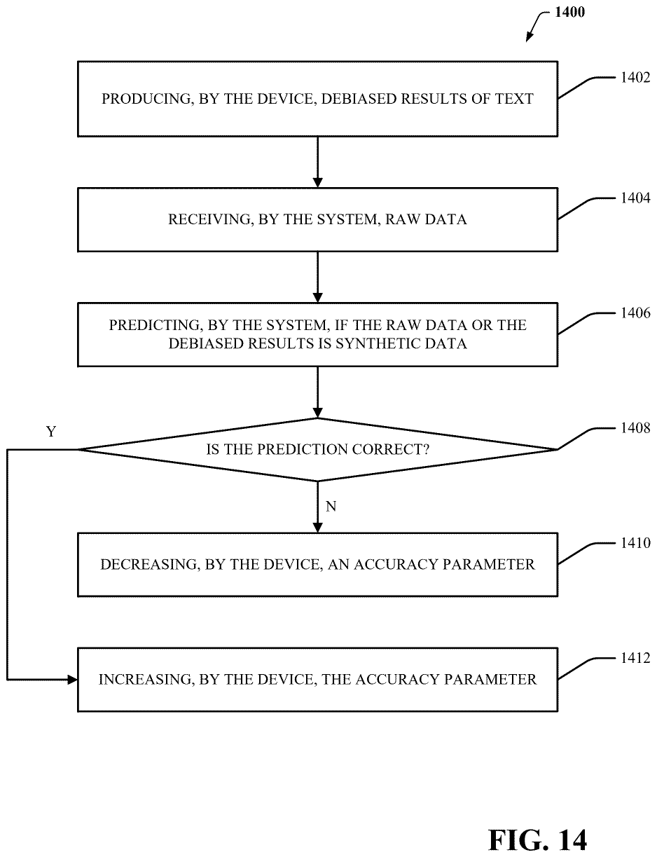

FIG. 14 illustrates a flow diagram of an example, non-limiting method 1400 that can facilitate bias detection and mitigation with quadratic algorithm selection in accordance with one or more embodiments described herein. Repetitive description of like elements and/or processes employed in respective embodiments is omitted for sake of brevity.

At 1402, non-limiting method 1400 can comprise producing (e.g., by selection component 208), by the system, debiased results of text.

At 1404, non-limiting method 1400 can comprise receiving (e.g., by selection component 208), by the system, raw data.

At 1406, non-limiting method 1400 can comprise predicting (e.g., by selection component 208), by the system, if the raw data or the debiased results is synthetic data.

At 1408, non-limiting method 1400 can comprise determining (e.g., by selection component 208), by the system, if the prediction is correct. If yes, non-limiting method 1400 can proceed to 1412. If no, non-limiting method 1400 can proceed to 1410.

At 1410, non-limiting method 1400 can comprise decreasing (e.g., by selection component 208), by the system, an accuracy parameter.

At 1412, non-limiting method 1400 can comprise increasing (e.g., by selection component 208), by the system, the accuracy parameter.

In various aspects, selection component 208 can predict which is the synthetic data for any number of samples of the raw data or the debiased results. For each prediction, selection component 208 can adjust the accuracy parameter based on if the prediction is correct or incorrect. After the accuracy parameter has been adjusted based on all samples of the raw text and debiased results, selection component 208 can calculate a liveness metric based on the resulting accuracy parameter.

FIG. 15 illustrates a block diagram of an example, non-limiting, operating environment 1500 in which one or more embodiments described herein can be facilitated. FIG. 15 and the following discussion are intended to provide a general description of a suitable operating environment 1500 in which one or more embodiments described herein at FIGS. 1-14 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1500 contains an example of an environment for the execution of at least some of the computer code involved in performing the inventive methods, such as bias detection and mitigation with quadratic algorithm selection code 1528. In addition to block 1528, computing environment 1500 includes, for example, computer 1501, wide area network (WAN) 1502, end user device (EUD) 1503, remote server 1504, public cloud 1505, and private cloud 1506. In this embodiment, computer 1501 includes processor set 1510 (including processing circuitry 1520 and cache 1521), communication fabric 1511, volatile memory 1512, persistent storage 1513 (including operating system 1522 and block 1528, as identified above), peripheral device set 1514 (including user interface (UI) device set 1523, storage 1524, and Internet of Things (IoT) sensor set 1525), and network module 1515. Remote server 1504 includes remote database 1530. Public cloud 1505 includes gateway 1540, cloud orchestration module 1541, host physical machine set 1542, virtual machine set 1543, and container set 1544.

COMPUTER 1501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1530. As is well understood in the art of computer technology, and depending upon the technology, performance of a computer-implemented method may be distributed among multiple computers and/or between multiple locations. On the other hand, in this presentation of computing environment 1500, detailed discussion is focused on a single computer, specifically computer 1501, to keep the presentation as simple as possible. Computer 1501 may be located in a cloud, even though it is not shown in a cloud in FIG. 15. On the other hand, computer 1501 is not required to be in a cloud except to any extent as may be affirmatively indicated.

PROCESSOR SET 1510 includes one, or more, computer processors of any type now known or to be developed in the future. Processing circuitry 1520 may be distributed over multiple packages, for example, multiple, coordinated integrated circuit chips. Processing circuitry 1520 may implement multiple processor threads and/or multiple processor cores. Cache 1521 is memory that is located in the processor chip package(s) and is typically used for data or code that should be available for rapid access by the threads or cores running on processor set 1510. Cache memories are typically organized into multiple levels depending upon relative proximity to the processing circuitry. Alternatively, some, or all, of the cache for the processor set may be located “off chip.” In some computing environments, processor set 1510 may be designed for working with qubits and performing quantum computing.

Computer-readable program instructions are typically loaded onto computer 1501 to cause a series of operational steps to be performed by processor set 1510 of computer 1501 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1521 and the other storage media discussed below. The program instructions, and associated data, are accessed by processor set 1510 to control and direct performance of the inventive methods. In computing environment 1500, at least some of the instructions for performing the inventive methods may be stored in block 1528 in persistent storage 1513.

COMMUNICATION FABRIC 1511 is the signal conduction path that allows the various components of computer 1501 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1512 is any type of volatile memory now known or to be developed in the future. Examples include dynamic type random access memory (RAM) or static type RAM. Typically, volatile memory 1512 is characterized by random access, but this is not required unless affirmatively indicated. In computer 1501, the volatile memory 1512 is located in a single package and is internal to computer 1501, but, alternatively or additionally, the volatile memory may be distributed over multiple packages and/or located externally with respect to computer 1501.

PERSISTENT STORAGE 1513 is any form of non-volatile storage for computers that is now known or to be developed in the future. The non-volatility of this storage means that the stored data is maintained regardless of whether power is being supplied to computer 1501 and/or directly to persistent storage 1513. Persistent storage 1513 may be a read only memory (ROM), but typically at least a portion of the persistent storage allows writing of data, deletion of data and re-writing of data. Some familiar forms of persistent storage include magnetic disks and solid state storage devices. Operating system 1522 may take several forms, such as various known proprietary operating systems or open source Portable Operating System Interface-type operating systems that employ a kernel. The code included in block 1528 typically includes at least some of the computer code involved in performing the inventive methods.

PERIPHERAL DEVICE SET 1514 includes the set of peripheral devices of computer 1501. Data communication connections between the peripheral devices and the other components of computer 1501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1523 may include components such as a display screen, speaker, microphone, wearable devices (such as goggles and smart watches), keyboard, mouse, printer, touchpad, game controllers, and haptic devices. Storage 1524 is external storage, such as an external hard drive, or insertable storage, such as an SD card. Storage 1524 may be persistent and/or volatile. In some embodiments, storage 1524 may take the form of a quantum computing storage device for storing data in the form of qubits. In embodiments where computer 1501 is required to have a large amount of storage (for example, where computer 1501 locally stores and manages a large database) then this storage may be provided by peripheral storage devices designed for storing very large amounts of data, such as a storage area network (SAN) that is shared by multiple, geographically distributed computers. IoT sensor set 1525 is made up of sensors that can be used in Internet of Things applications. For example, one sensor may be a thermometer and another sensor may be a motion detector.

NETWORK MODULE 1515 is the collection of computer software, hardware, and firmware that allows computer 1501 to communicate with other computers through WAN 1502. Network module 1515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1515 are performed on the same physical hardware device. In other embodiments (for example, embodiments that utilize software-defined networking (SDN)), the control functions and the forwarding functions of network module 1515 are performed on physically separate devices, such that the control functions manage several different network hardware devices. Computer-readable program instructions for performing the inventive methods can typically be downloaded to computer 1501 from an external computer or external storage device through a network adapter card or network interface included in network module 1515.

WAN 1502 is any wide area network (for example, the internet) capable of communicating computer data over non-local distances by any technology for communicating computer data, now known or to be developed in the future. In some embodiments, the WAN 1502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1503 is any computer system that is used and controlled by an end user (for example, a customer of an enterprise that operates computer 1501), and may take any of the forms discussed above in connection with computer 1501. EUD 1503 typically receives helpful and useful data from the operations of computer 1501. For example, in a hypothetical case where computer 1501 is designed to provide a recommendation to an end user, this recommendation would typically be communicated from network module 1515 of computer 1501 through WAN 1502 to EUD 1503. In this way, EUD 1503 can display, or otherwise present, the recommendation to an end user. In some embodiments, EUD 1503 may be a client device, such as thin client, heavy client, mainframe computer, desktop computer and so on.

REMOTE SERVER 1504 is any computer system that serves at least some data and/or functionality to computer 1501. Remote server 1504 may be controlled and used by the same entity that operates computer 1501. Remote server 1504 represents the machine(s) that collect and store helpful and useful data for use by other computers, such as computer 1501. For example, in a hypothetical case where computer 1501 is designed and programmed to provide a recommendation based on historical data, then this historical data may be provided to computer 1501 from remote database 1530 of remote server 1504.

PUBLIC CLOUD 1505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1505 is performed by the computer hardware and/or software of cloud orchestration module 1541. The computing resources provided by public cloud 1505 are typically implemented by virtual computing environments that run on various computers making up the computers of host physical machine set 1542, which is the universe of physical computers in and/or available to public cloud 1505. The virtual computing environments (VCEs) typically take the form of virtual machines from virtual machine set 1543 and/or containers from container set 1544. It is understood that these VCEs may be stored as images and may be transferred among and between the various physical machine hosts, either as images or after instantiation of the VCE. Cloud orchestration module 1541 manages the transfer and storage of images, deploys new instantiations of VCEs and manages active instantiations of VCE deployments. Gateway 1540 is the collection of computer software, hardware, and firmware that allows public cloud 1505 to communicate through WAN 1502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1506 is similar to public cloud 1505, except that the computing resources are only available for use by a single enterprise. While private cloud 1506 is depicted as being in communication with WAN 1502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1505 and private cloud 1506 are both part of a larger hybrid cloud.

CLOUD COMPUTING SERVICES AND/OR MICROSERVICES (not separately shown in FIG. 15): private and public clouds 1506 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an identification component that identifies one or more entities in one or more utterances;
a simulation component that generates simulated utterances based on the one or more entities;
a model component that executes the simulated utterances on nodes of a natural language processing (NLP) model to identify bias; and
a selection component that mitigates the bias by selecting one or more debiasing methods using quadratic algorithm selection.

2. The system of claim 1, wherein generating the simulated utterances comprises:
identifying respective matching equivalents of the one or more entities;
forming one or more stub sentences by replacing the one or more entities with the respective matching equivalents; and
executing the one or more stub sentences on the nodes of the NLP model.

3. The system of claim 1, wherein the quadratic algorithm selection uses a binary selector to select the one or more debiasing methods based on a quadratic function.

4. The system of claim 1, wherein the one or more debiasing methods comprise fair pre-processing, fair in-processing or fair post-processing.

5. The system of claim 3, wherein the selection component minimizes the quadratic function to select a minimum number of the one or more debiasing methods.

6. The system of claim 3, wherein the selection component minimizes the quadratic function based on a liveness metric.

7. The system of claim 6, wherein the selection component measures the liveness metric using Generative Adversarial Networks (GANs), wherein a generator produces debiased results, and wherein a discriminator determines if the debiased results are synthetic data.

8. The system of claim 7, wherein the liveness metric equals an inverse of an accuracy of the discriminator.

9. The system of claim 1, wherein the simulated utterances comprise inter-utterances or intra-utterances.

10. The system of claim 1, further comprising:
a display component that displays, via a user interface, corresponding bias factors for the one or more entities.

11. The system of claim 1, wherein the NLP model employs a large language model.

12. A computer-implemented method, comprising:
identifying, by a system operatively coupled to a processor, one or more entities in one or more utterances;
generating, by the system, simulated utterances based on the one or more entities;
executing, by the system, the simulated utterances on nodes of a natural language processing (NLP) model to identify bias; and
mitigating, by the system, the bias by selecting one or more debiasing methods using quadratic algorithm selection.

13. The computer-implemented method of claim 12, wherein generating the simulated utterances comprises:
identifying respective matching equivalents of the one or more entities;
forming one or more stub sentences by replacing the one or more entities with the respective matching equivalents; and
executing the one or more stub sentences on the nodes of the NLP model.

14. The computer-implemented method of claim 12, wherein the one or more debiasing methods comprises fair pre-processing, fair in-processing or fair post-processing.

15. The computer-implemented method of claim 12, wherein the quadratic algorithm selection uses a binary selector to select the one or more debiasing methods based on a quadratic function.

16. The computer-implemented method of claim 15, further comprising:
minimizing, by the system, the quadratic function to select a minimum number of the one or more debiasing methods; and
minimizing, by the system, the quadratic function based on a liveness metric.

17. The computer-implemented method of claim 16, further comprising:
measuring, by the system, the liveness metric using Generative Adversarial Networks (GANs), wherein a generator produces debiased results, and wherein a discriminator determines if the debiased results are synthetic data.

18. The computer-implemented method of claim 17, wherein the liveness metric equals an inverse of an accuracy of the discriminator.

19. A computer program product for implicit bias detection and mitigation, the computer program product comprising a computer readable storage medium having program instructions embodied therewith, the program instructions executable by a processor to cause the processor to:
identify, by the processor, one or more entities in one or more utterances;
generate, by the processor, simulated utterances based on the one or more entities;
execute, by the processor, the simulated utterances on nodes of a natural language processing (NLP) model to identify bias; and
mitigate, by the processor, the bias by selecting one or more debiasing methods using quadratic algorithm selection.

20. The computer program product of claim 19, wherein generating the simulated utterances comprises:
identifying respective matching equivalents of the one or more entities;
forming one or more stub sentences by replacing the one or more entities with the respective matching equivalents; and
executing the one or more stub sentences on the nodes of the NLP model.
